(19) United States
(12) Patent Application Publication
(10) Pub. No.: US 2025/0356536 A1
(43) Pub. Date: Nov. 20, 2025

(54) ATTENTION-BASED VIDEO TOKEN GENERATION

(71) Applicant: Google LLC, Mountain View, CA (US)

(72) Inventors: Daniel Alex Kondratyuk, Kirkland, WA (US); Lijun Yu, Pittsburgh, PA (US); Xiuye Gu, Mountain View, CA (US); José Lezama Torres de la Llosa, Atlanta, GA (US); Bryan Andrew Seybold, San Francisco, CA (US); Lu Jiang, Mountain View, CA (US)

(21) Appl. No.: 18/666,415

(22) Filed: May 16, 2024

(51) Int. Cl. G06T 11/00; G06F 40/284; G06T 3/4046; G06T 3/4053; G06T 5/77; G10L 19/00; G10L 19/038; G10L 25/30

(52) U.S. Cl. CPC G06T 11/00; G06F 40/284; G06T 3/4046; G06T 3/4053; G06T 5/77; G10L 19/038; G10L 25/30; G06T 2207/10016; G10L 2019/0004

(57) ABSTRACT

Methods, systems, and apparatus, including computer programs encoded on a computer storage medium, for generating a video output using an autoregressive token generation neural network model In one aspect, a system comprises obtaining a model input, processing the model input to generate an input sequence of embeddings that represents the model input, autoregressively generating a plurality of output sequences of tokens, wherein each output sequence of tokens corresponds to a respective output modality of tokens from a set of a plurality of modalities that includes a video modality and one or more other modalities, and generating a model output that includes a video output of the video modality by decoding the sequence of tokens.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input generate an output.

### SUMMARY

This specification describes a system implemented as computer programs on one or more computers in one or more locations that can generate a high-quality video with matching audio using an autoregressive token generation neural network model (“autoregressive token generation model”).

More specifically, the system can generate a sequence of embeddings that represent a model input and can process the sequence of embeddings to generate different output sequences of tokens using the autoregressive token generation model, e.g., different output sequences that correspond with one or more output modalities. The autoregressive token generation model can function as a versatile multitask video generation model and can perform tasks such as text-to-video, image-to-video, video editing and video-to-video stylization depending on a task token included in the sequence of embeddings that represent the model input.

According to a first aspect there is provided a method for receiving a model input, processing the model input to generate an input sequence of embeddings that represents the model input, autoregressively generating, by processing the input sequence of embeddings using an auto-regressive token generation neural network, a combined output sequence that comprises a plurality of output sequences of tokens from a unified vocabulary of tokens, wherein each output sequence of tokens corresponds to a respective output modality of tokens from a set of a plurality of modalities that includes a video modality and one or more other modalities, and generating a model output that includes the video modality and the one or more other modalities, comprising, for each output sequence of tokens, decoding the sequence of tokens using a decoder neural network corresponding to the modality of the output sequence to generate an output of the modality of the output sequence.

Particular embodiments of the subject matter described in this specification can be implemented so as to realize one or more of the following advantages.

The system of this specification can generate high-quality video with matching audio for a number of video generation tasks using a unified model. In particular, the system can employ a decoder-only transformer model as the autoregressive token generation model that can process tokenized and embedded multimodal inputs, e.g., one or more of image, video, text, and audio input, to generate tokens from a unified vocabulary.

The autoregressive token generation model can exhibit zero-shot video generation capabilities. In particular, the system can generalize from data seen during training, e.g., in generating high-fidelity video content from text, image, or video modality inputs that diverge from the training data distribution. In particular, the system can perform new video generation tasks, e.g., by learning to sequentially chain multimodal training tasks together. The ability to generalize through conditioning allows for the autoregressive generation of longer coherent video and corresponding audio sequences, e.g., up to 10 seconds.

In some cases, the system is able to generate a high-resolution video output by further processing image tokens generated using the autoregressive token generation model using a non-autoregressive video transformer with windowed-local attention mechanism. In particular, the system can generate a high-resolution video output using fewer computational resources relative to generating a high-resolution video autoregressively, e.g., by generating high-resolution tokens using the autoregressive token generation model. In particular, the system can process the image tokens generated by the autoregressive token generation model and increase the video resolution within the latent token space using token factorization and by attending the image tokens with corresponding high-resolution image tokens, e.g., using windowed attention along each of a temporal, spatial vertical, and spatial horizontal axis.

The decoder-only transformer model can also be straightforwardly and synergistically trained on a multi-task multimodal generative objective, e.g., on a set of training tasks including text-to-video, image-to-video, video editing and video-to-video generation. In particular, training on a multi-task multimodal objective can allow for the generation of high-fidelity video with realistic complex motions, e.g., motions driven by text or another input modality. As another example, the unified model can facilitate training even when there is a disparity in the size of labeled data sets for each input modality, e.g., labeled video-text pair data sets are not as prevalent as labeled image data sets.

Furthermore, the system can leverage task adaptation to reduce computational resources relative to standard diffusion model approaches to video generation tasks, e.g., where architectural changes and adapter modules are the dominant approach used to adapt a model to more diverse tasks. More specifically, rather than training many versions of the same autoregressive token generation model for particular multimodal generative tasks, the system can use task adaptation to adapt the pretrained foundation model for each multimodal generative task.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an overview an example attention-based video generation system that includes an autoregressive token generation model 150.

FIG. 2 illustrates an example implementation of processing a multimodal input using respective encoder models and an autoregressive token generation model to generate a model output including a video.

FIG. 3 depicts an example super-resolution engine, e.g., that can be used by the attention-based video generation system to generate a super-resolution video output from the model output.

FIG. 4 demonstrates an example of task chaining performed by the example attention-based video generation system of FIG. 1.

FIG. 5 depicts user preference results for the autoregressive token generation model of FIG. 2.

FIG. 6 is a flow chart of an example process for processing a model input to generate a video output using an autoregressive attention-based video generation system.

Like reference numbers and designations in the various drawings indicate like elements.

### DETAILED DESCRIPTION

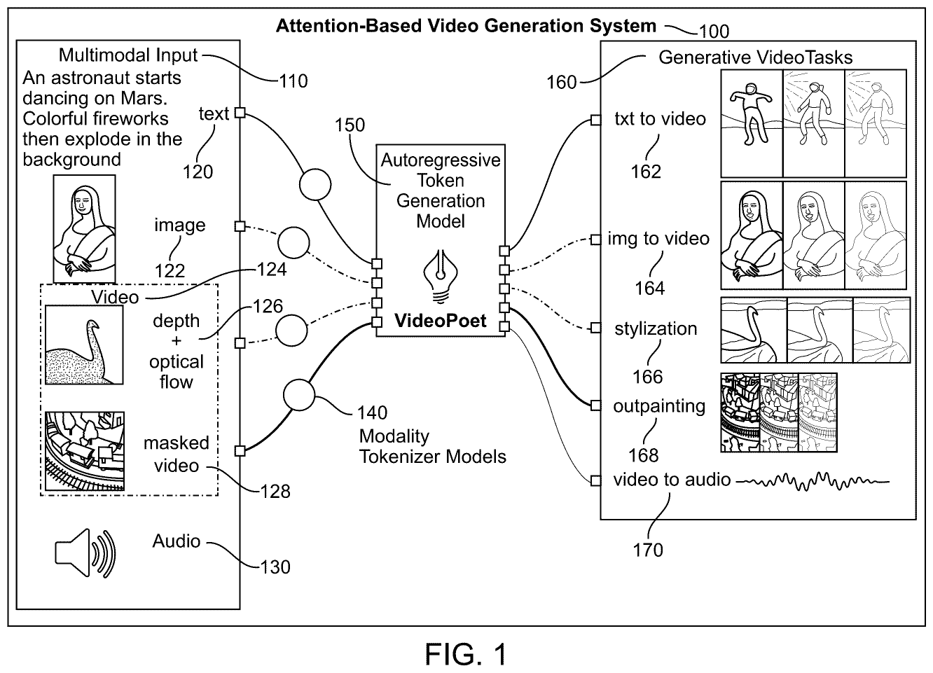

FIG. 1 provides an overview of using an example attention-based video generation system 100 to perform one or more video generative tasks. The attention-based video generation system 100 is an example of a system implemented as computer programs on one or more computers in one or more locations in which the systems, components, and techniques described below are implemented.

In particular, the attention-based video generation system 100 can receive a model input, e.g., a multimodal input 110. As an example, the multimodal input 110 can include one or more of a text input 120, image input 122, video input 126, or audio input 130 modalities, as will be described in more detail below. In some cases, the system 100 can receive the model input from a user-device. The system can then process the model input using an autoregressive token generation model 150 to generate a high-quality video output with corresponding audio.

As an example, the text input 112 can include a text prompt that contains explicit instructions on the video the system can generate, e.g., “an astronaut starts dancing on Mars. Colorful fireworks then explode in the background”, as depicted. As another example, the text input 112 can include a document, e.g., a syllabus, essay, play, etc., that provides characters, a setting, or a plot for the video. As yet another example, the text input 112 can include text from a webpage, e.g., a new article, book review, social media post, etc., that provides content, a setting, or style for the video.

As an example, the image input 122 can include an image, e.g., an image located using an internet search, a photo taken using a digital camera, etc. As another example, the image input 122 can include an image of a digital sketch, a screenshot of a flow chart or diagram, or an image of a negative on a light-box. As yet another example, the image input 122 can include scanned artwork, e.g., a scanned depiction of a character, a portrait, or an image of an abstract painting.

As an example, the video input 124 can include either video with a corresponding audio track or silent video, e.g., a short film clip, a time-lapse video, or a live-stream. As another example, the video input 126 can include a music video, a broadcasted sports game, a virtual reality experience or vlog. As yet another example, the video input 126 can include a video of a conversation in sign-language.

As an example, the audio input 130 can include a sound waveform, e.g., a recorded voice, e.g., a dictated note, a phone call, etc., or sampled sound. As another example, the audio input 130 can include a song, a rhythm, or an audio effect, e.g., an echo. As yet another example, the audio input 130 can include a radiofrequency signal, e.g., pulse radar, sonar, or lidar signals.

In some cases, the system can receive a preprocessed model input, e.g., an image 122 or video 124 input can be resized or compressed. In other cases, the system 100 can process a raw image input 124 or video input 126, e.g., to resize the image or video. As another example, the system 100 can receive one or more pre-processed video inputs 124, e.g., the depth and optical flow maps 126 or a masked video 128 input. Likewise, the system 100 can process a raw video input 124 to generate the depth and optical flow maps 126 or masked video input 128.

For example, the system 100 can estimate the depth of a video frame, e.g., the distance from the observer, e.g., a camera, to the content of each pixel in the video frame, can be estimated using image analysis techniques. As another example, the system 100 can determine the optical flow of a video input 124 by calculating the direction and magnitude of pixel displacement in an established time sequence of video frames, e.g., by applying monocular depth maps, using a differential-method, etc. As yet another example, the system 100 can generate the masked video 128 by applying pixel masks, e.g., binary masking, a Mask R-CNN, optical flow-based masking, etc., to the raw video input 124. In particular, the system 100 can use the depth and optical flow input 126 to provide more specific structural and motion data, e.g., data that can be used for generating a high-fidelity motion that matches an existing video; and the system 100 can use the masked video to expand the size of a video or replace an object.

In particular, the system 100 can use the multimodal input 110 to inform the generation of a complex desired video output. For example, the system 100 can receive a multimodal input 110 including an image of a polar bear and a video of a background dancer from a music video and can generate a video of the polar bear doing the dance from the music video. As another example, the system 100 can receive a multimodal input 110 including the prompt “Animate this photograph” with a photograph of a landscape and can generate a video panning over the landscape. As yet another example, the system 100 can receive a multimodal input 110 including an audio stating “A map of the United States made of sushi. Pieces of the sushi disappear one by one” and can generate a video of the sushi map being consumed. As a further example, the system 100 can receive a multimodal input 110 of a masked video of a man shopping in a store with an image of a cubist painting of a still life and can generate an outpainted masked video in the style of the painting.

To generate the video, the system 100 can process the multimodal input 110 to generate an input sequence of embeddings that represents the model input. In particular, the system 100 can tokenize the model input and embed the resulting tokens, directly encode the model input, or both, as will be described in more detail below.

For example, the system can process one or more of the text 120, image 122, video 124, and audio 130 inputs using modality tokenizer models 140 to generate a corresponding input sequence of tokens for each modality in the multimodal input 110 and can then embed the input sequence of tokens using an embedding model or an embedding layer of the autoregressive token generation model 150. In the particular example depicted, the system 100 can process each modality using a respective tokenizer model 140, e.g., the text input 120 with a text tokenizer and, the image input 122 with an image tokenizer, the video input 124 with a video tokenizer, and the audio input 130 with an audio tokenizer. In some cases, the system can process the image input 122 and the video input 124 with a combined visual tokenizer.

More specifically, the system can generate a respective sequence of tokens for each modality and can then process each input sequence of tokens using a respective embedding model or an embedding layer of the autoregressive token generation model 150 to generate an embedding relating a meaningful feature representation that includes the content and context from each of the text 120, image 122, video 124, and audio 130 inputs, respectively.

In the case the system uses an embedding model, each of the embedding models can be a neural network with any appropriate machine learning architecture that can be configured to process the respective input sequence of tokens to generate a representation of the content and context of the data in a latent embedding space, e.g., a multi-dimensional space of a different size or shape than the size or shape of the input. For example, the embedding models can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

As another example, the system can directly encode one or more of the input modalities using a respective modality encoder model, e.g., without first tokenizing the input. In this case, each of the modality encoder models can be a neural network with any appropriate machine learning architecture that can be configured to process the respective modality input to generate a representation of the input in a latent embedding space, e.g., a multi-dimensional space of a different size or shape than the size or shape of the input.

For example, the modality encoder model can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers). As an example, a text or audio encoder model can be implemented as an embedding neural network, e.g., a recurrent neural network (RNN) or an encoder-only Transformer. As another example, an image or video encoder model can be implemented as a convolutional neural network (CNN) or a Vision Transformer (ViT).

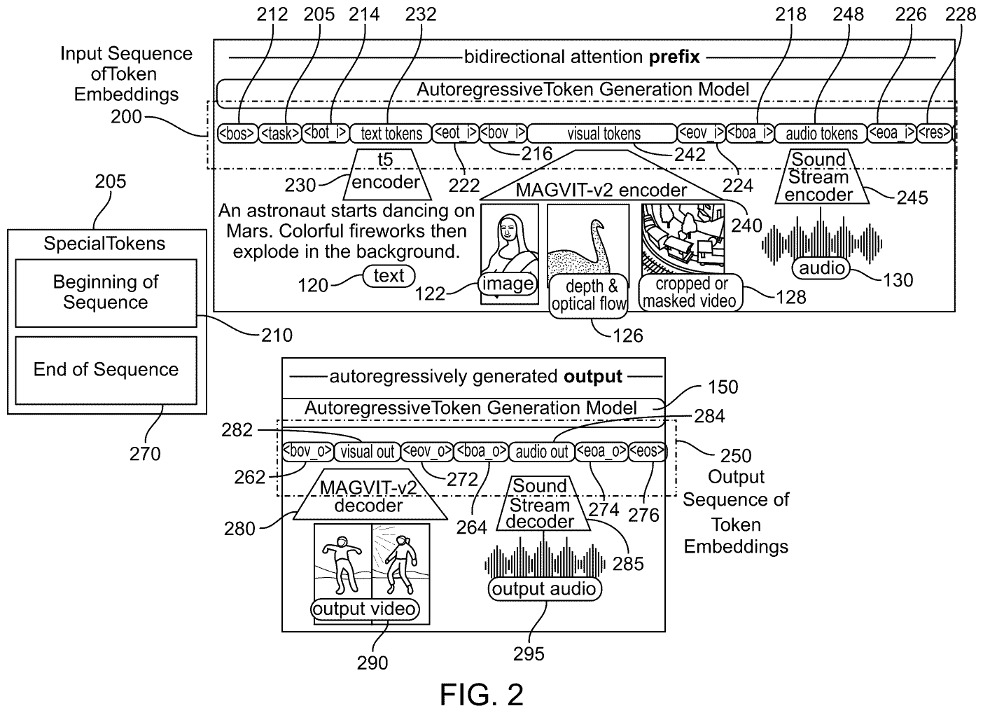

As yet another example, the system can process a subset of the inputs using respective modality tokenizers 140 and the remaining subset of inputs using respective embedding models. An example in which the system uses modality tokenizer models 140 to process the image 122, video 124, and audio 130 inputs before embedding the corresponding sequences of tokens and uses a text encoder model to process the text 122 input to directly generate text embeddings will be described in more detail in FIG. 2.

The system can then combine the respective embeddings generated for each modality of the multimodal input into the input sequence of embeddings. As an example, the system can concatenate the respective embeddings while maintaining distinct modalities, e.g., using beginning and ending modality tokens. In this case, the concatenation can be in a particular order, e.g., the text embeddings can be concatenated to the video embeddings and then to the audio embeddings, or in any order, e.g., additionally, the video embeddings can be concatenated to the audio embeddings and then to the text embeddings.

The system can then process the input sequence of embeddings using the autoregressive token generation model 150 to generate an output, e.g., as specified by one or more generative video tasks 160. More specifically, the system can autoregressively generate sequences of tokens for each output modality, e.g., each modality as required by the specific generative task, from the same vocabulary of tokens, e.g., a defined fixed-size set of words and concepts that can be generated across the modalities. In particular, the unified vocabulary can allow for nuanced data sharing between the different modalities during autoregressive token generation in order to enhance the quality and togetherness of the output sequence of tokens. The autoregressive token generation model 150 can also leverage the shared vocabulary to operate in a resource-constrained environment, e.g., in an at-edge device, since generating the output from a fixed-size vocabulary for all modalities provides a limit on the amount of resources required for generating the output.

The autoregressive token generation model 150 can be a neural network with any appropriate machine learning architecture that can be configured to process the input sequence of tokens to autoregressively generate an output sequence of tokens. For example, the autoregressive token generation model 150 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

More specifically, the autoregressive token generation model 150 can generate each particular token in the output sequence of tokens by conditioning on the current output sequence that includes tokens preceding the particular token being generated in the output sequence. As an example, the autoregressive token generation model 150 can have a recurrent neural network architecture that is configured to sequentially process an input sequence of embeddings and trained to perform next element prediction, e.g., to define a likelihood score distribution over a set of next elements. More specifically, the autoregressive token generation model 150 can be a recurrent neural network (RNN), long short-term memory (LSTM), or gated-recurrent unit (GRU).

As another example, the neural network can be an auto-regressive Transformer-based neural network that includes (i) a plurality of attention blocks that each apply a self-attention operation and (ii) an output subnetwork that processes an output of the last attention block to generate the score distribution.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer. More specifically, the system 100 can generate sequences of tokens using the autoregressive token generation model 150 for one or more output modalities from the unified vocabulary of tokens in line with one or more generative video tasks 160. For example, the system 100 can process a text input 120 to generate a video in a text to video task 162 or an image input 122 to generate a video in an image to video task 164. As another example, the system 100 can process a video input 126 to generate a stylized video, e.g., a video with different aesthetic style than the input video, in a stylization task 166. As yet another example, the system 100 can process a video input 126 to generate an outpainted video, e.g., a video with extended image beyond the input frame, in an outpainting task 168. In another case, the system can generate an inpainted video in an inpainting task. As another example, the system can process a video 126 without audio to generate a video with audio in a video to audio task 170.

In some cases, the autoregressive token generation model 150 can be a pretrained decoder-only video generation model. For example, the decoder-only video generation model 150 can have been pretrained on a mixture of multimodal pretraining objectives, e.g., multimodal pretraining objectives corresponding with each of the generative video tasks 160, e.g., using standard transformer training techniques. For example, the values of the parameters of the autoregressive token generation model 150 can be trained by iteratively calculating and backpropagating gradients of the multimodal objective function, e.g., a loss function determined by comparing the generated output to a ground truth output, using the update rule of any appropriate gradient descent optimization algorithm, e.g., RMSprop or Adam. In some cases, the system can use accelerated alternating gradient descent, e.g., by alternating between updating different sets of parameters using the objective function. In particular the model 150 can have been trained using one or more task tokens, e.g., as will be described in more detail in FIG. 2. After pretraining, the decoder-only generation model can function as a versatile multitask video generation model such as text-to-video, image-to-video, video editing and video-to-video stylization.

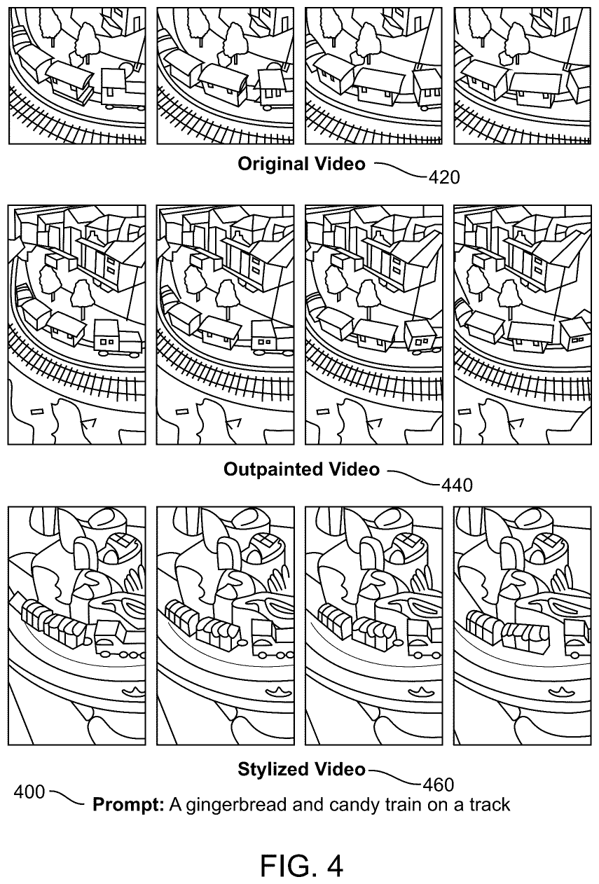

During subsequent task-adaptation, the pretrained autoregressive token generation model 150 can be further fine-tuned either to enhance the generation quality on the training tasks or to perform new tasks, e.g., rather than relying on a separate diffusion model controlled by text prompts for video generation, the system can inherently integrate multiple task capabilities in a unified model. Furthermore, the autoregressive token generation model 150 can handle tasks that were not included in the model 150 training, e.g., by chaining training tasks together as will be covered in more detail in FIG. 4.

FIG. 2 illustrates using an example autoregressive token generation model, e.g., the autoregressive token generation model 150 of FIG. 1, to generate a model output including a video output. In particular, FIG. 2 provides more details on how the attention-based video generation system 100 of FIG. 1 can encode the one or more modalities of the model input and decode the one or more modalities of the model output.

More specifically, the system can tokenize each of the respective input modalities using pretrained tokenizer models, embed the corresponding input sequence of tokens for each modality, and autoregressively generate the output sequence of tokens using the autoregressive token generation model 150. The system can then combine, e.g., concatenate, the respective embeddings into the input sequence of embeddings for processing by the autoregressive token generation model 150. In particular, the system can embed each of the modalities into the input space of the model 150, e.g., a space representing a unified vocabulary.

For example, the system can process the model input, e.g., the multimodal input 110 of FIG. 1, using respective pretrained encoders for each modality to generate respective embeddings or respective tokens that can be embedded. As mentioned previously, the autoregressive token generation model 150 can receive and process an input sequence of embeddings 200. In the particular example depicted, the system can use a text encoder model 230 to process the text 122 input to directly generate text embeddings as a subset of the input sequence of embeddings; and can use respective modality tokenizer models 240 and 245 to process the image 122, video 124, and audio 130 inputs, respectively to generate corresponding tokens that the system can embed, e.g., using an embedding model, to generate corresponding sequences of embeddings as subsets of the input sequence of embeddings 200. In this case, the visual encoder 240 and the audio encoder 245 refer to respective encoder models that each include a tokenizer and embedding model.

As an example, the system can directly process the text modality input 120 to generate an input sequence of embeddings that represents the text modality input, e.g., the text token embeddings 232. In the particular example depicted, the system can use a text encoder neural network 230, e.g., a pretrained language embedding model, e.g., a pretrained t5 (text-to-text transfer transformer) as described in Raffel, C., et. al. “Exploring the Limits of Transfer Learning with a Unified Text-to-Text Transformer” (10.48550/arXiv.1910.10683) to process the text modality input 120 to generate a sequence of text embeddings. In this case, the generated text embeddings can be mapped from the output space of the text encoder 230 to a subset of embeddings in the input sequence of embeddings, e.g., by projecting the text encoder's embedding space into the input space of the model 150 with a linear transformation, e.g., using a linear layer, to generate the text token embeddings 232. As another example, the generated text embeddings can be mapped from the text output space to the model 150 input space using a kernel or adversarial alignment method.

As another example, the system can process the image or video modality input, e.g., one or more of the inputs 122, 126, or 128, using a visual tokenizer 240, e.g., a MAGVIT-v2 encoder as described in Yu, L., et. al. “Language Model Beats Diffusion-Tokenizer is Key to Visual Generation” (10.48550/arXiv.2310.05737), to generate the visual token embeddings 242. For example, the visual encoder 240 can quantize a video into spatial-temporal visual tokens, e.g., the system can encode the video modality input at a determined cadence of every N frames, e.g., every 4, 6, 10 frames. As another example, the system can encode the video modality input at determined cadence of N frames per second (fps), e.g., the system can sample at 8, 16, or 64 fps. In this case, encoding the video modality input refers to quantizing the video clip into a sequence of integers, with a decoder mapping the integers back into the pixel space. The token embeddings can then be concatenated, e.g., along the temporal dimension. In some cases, the token embeddings can be flattened after concatenation.

In particular, the visual encoder 240 can be a temporally-consistent tokenizer that can enforce temporal consistency, e.g., temporal dependency by encoding the sequence of video frames without any information from future frames. The system can also encode the image modality input 122 as a single video frame using the visual encoder 240. Since the same encoder 240 is used for both video and image inputs, the visual tokens 242 are automatically generated in a space of the same vocabulary. In particular, the visual encoder 240 can encode the first frame of a video separately, e.g., into a first token embedding. In this case, an image can be processed as the first frame of an input sequence of video frames in which there is only one frame.

The ability to use the same visual encoder 240 for both image and video inputs can enable the system to seamlessly incorporate both text-paired and unpaired video data during training. In particular, being able to train the visual encoder 240 with images can provide many learnable characteristics that are not typically represented in videos, e.g., strong visual styles and objects which area infrequently seen in videos, which can enhance the quality of the generated output video. Furthermore, in some cases, the system can rely on training the visual encoder 240 with a greater proportion of text-image paired training data, e.g., since labeled text-image paired data can be more readily available than labeled video data. In particular, the system can sample a larger portion of the training set from a dataset of labelled image-text pairs for a first number of training iterations and can sample a larger portion of the training set of model inputs from unlabeled video-only data for the remaining training iterations.

In the case that the visual inputs are masked or cropped 128, the system can first encode the masked or cropped input 128, e.g., using Conditional Masked Modeling by Interior Tokens (COMMIT) as described in Yu, L., et. al. “MAGVIT: masked Generative Video Transformer” (10.48550/arXiv.2212.05199), before processing with the visual encoder 240. In the case that the inputs are depth and optical flow maps 124, the depth and optical flow maps 124 are converted to red-green-blue (RGB) format, and then treated as standard videos. For example, the system can map each one-dimensional value in a depth map or two-dimensional optical flow value, e.g., (x displacement, y displacement) value, to a three-dimensional value (R, G, B) by some technique before processing with the visual encoder 240.

As yet another example, the system can encode the audio modality input 130 using a residual vector quantizer (RVQ), e.g., the Sound Stream encoder 242 as described in Zeghidour, N., et. al. “SoundStream: An End-to-End Neural Audio Codec” (10.48550/arXiv.2107.03312), to generate the audio token embeddings 248. An RVQ is a vector autoregressive model that incorporates a residual calculation to capture information that cannot be accurately predicted using a linear predictor and stores the calculated residual in a codebook of vectors, e.g., a codebook for specified frequencies of the audio modality input, such that a corresponding calculated residual can be added to a predicted value for reconstruction at a given frequency. In this case, the audio encoder 242 can encode the audio input at an RVQ of one or more levels, e.g., two, four, five, etc. levels. In this case, a greater number of levels allows for progressive refinement of the captured encoded representation, e.g., each level can capture a different frequency of the audio input.

The system can combine, e.g., concatenate, the respective token embeddings, e.g., the text token embeddings 232, the visual token embeddings 242, and the audio token embeddings 248, into the input sequence of embeddings 200. In the particular example depicted, the system can maintain a notion of input modality in the combined input sequence 200 using one or more special input tokens 200. In this case, the input tokens 200 include a set of special tokens 205 designating the beginning of the whole token sequence, e.g., the beginning of sequence token 212, and the beginning 200 and end 270 of each modality sequence.

The system can also prepend a task token 202 to the input sequence 200. For example, the system can have a separate token for each task e.g., a token that indicates the particular task the autoregressive token generation model 150 can perform by processing the inputs, to the input sequence 200, e.g., after the beginning of sequence token 212. In this case, the task token can be used to condition the output in accordance with each multimodal generative task. As another example, the system can have a separate token for each output modality type, e.g., the system can condition on a unique token for each unique output modality type. In particular, changes in the input modality types do not always require a new task, e.g., the model can learn how to incorporate a mixture of context signals for the same output type. As an example, text-to-video, image-to-video, and unconditioned video generation can all use the same task token.

For example, the system can prepend a beginning of sequence token 210 to the start of each modality sequence and can append an end of sequence token 270 to the end of each modality sequence in the input sequence. More specifically, the system can prepend a beginning of text token 214 token and can append an end of text token 222 to the text token embeddings 232; the system can prepend a beginning of visual token 216 token and can append an end of visual token 224 to the visual token embeddings 242; and the system can prepend a beginning of audio token 218 token and can append an end of audio token 224 to the audio token embeddings 248.

The system can then process the input sequence of embeddings 200 using the autoregressive token generation model 150. As an example, the autoregressive token generation model 150 can be implemented as a prefix language model with a decoder-only architecture. A prefix language model is a language model that can generate an output conditioned on a prefix sequence of tokens, e.g., using the context from one or more preceding tokens. In particular, the model 150 can process the input sequence 200, e.g., the prefix, with causal masking disabled such that the attention mechanism is not limited to only previous tokens in the sequence 200, and the model 150 can then generate the output 250 autoregressively with causal masking enabled, e.g., to only attend each generated token to previous tokens in the sequence. In this case, the prefix language model can employ a bidirectional prefix attention mechanism, e.g., the model can generate each output token in the output by conditioning on a prefix sequence of tokens that uses context determined from one or more preceding tokens and one or more succeeding tokens in the input sequence 200.

More specifically, the model 150 can capture information from both the preceding and succeeding tokens from the input sequence 200, e.g., by attending the N preceding token embeddings and M succeeding token embeddings, to generate the next token embedding in the output sequence. As an example, the autoregressive token generation model 150 can use a bidirectional attention mechanism for a predefined number of generated token embeddings at the beginning of the output sequence 250, e.g., the model 150 can use information from both preceding generated tokens and a number of specified preceding and succeeding tokens in the input sequence to generate the first few tokens in the output sequence 250 and can then perform causal self-attention with the rest of the output tokens in the sequence. In some cases, using bidirectional attention to generate the output sequence 250 can enable the model 150 to generate coherent outputs with longer-range context.

In the particular example depicted, the model 150 can be configured to generate a separate output sequence for each modality, e.g., a separate visual output 282 and one or more other output modality sequences, e.g., an audio output 284, text output, etc. Similarly to the input sequence 200, the system can use one or more output tokens special tokens 205 to designate the end of the whole token sequence 270 as well as the beginning and ending of each modality output sequence. For example, the system can prepend a beginning of visual output token 262 and append an end of visual output token 272 to the visual output sequence 282; and the system can prepend a beginning of audio output token 264 and append an end of audio output token 274 to the audio output sequence 284.

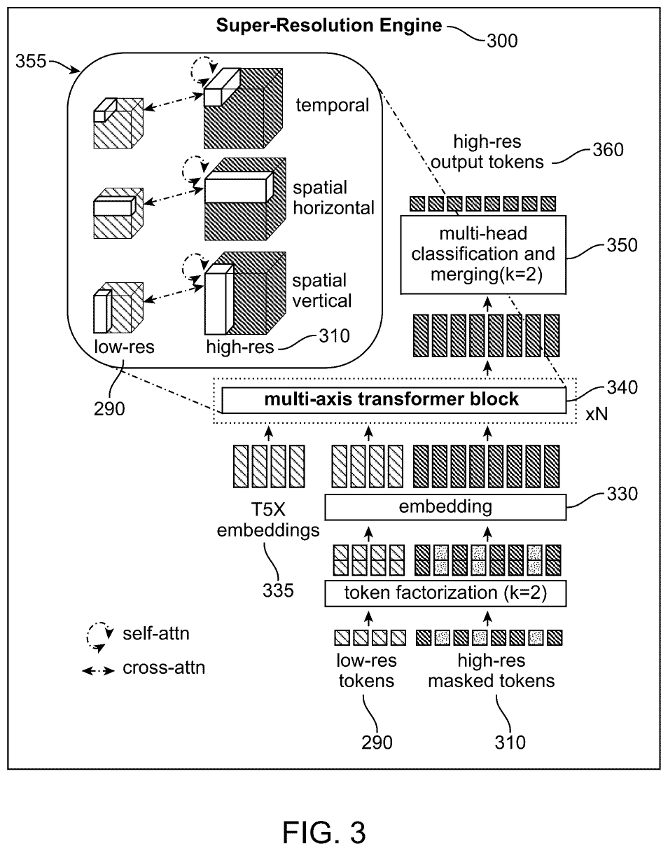

In particular, the autoregressive token generation model 150 can generate a sequence of video modality tokens, e.g., a sequence of image modality tokens with corresponding audio modality tokens. In some cases, the system can generate super-resolution video output tokens, e.g., the system can generate a sequence of super-resolution image tokens using a super-resolution engine, as will be described in more detail with respect to FIG. 3. In this case, the model 150 can also process a special token that indicates the output resolution for the video, e.g., the resolution token 228.

The system can then decode the output sequence 250, e.g., using one or more respective decoder models for each output modality. Each of the modality decoder models can be a neural network with any appropriate machine learning architecture that can be configured to process the output token embeddings corresponding with the respective modality input to generate an output, e.g., an output video 290, an output audio 295, etc. For example, the modality decoder model can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

As an example, a text decoder model can be implemented as a long-short term memory (LSTM) decoder, gated recurrent unit (GRU) decoder, attention-based decoder, etc. As another example, an image decoder model can be implemented as a convolutional neural network (CNN), generative adversarial network (GAN), variational decoder, etc. As yet another example, a video encoder model can be implemented as a convolutional LSTM, GAN, convolutional decoder, etc. As a further example, an audio encoder model can be implemented as a CNN, RNN, variational decoder, etc.

In some cases, the system can use decoders that correspond with the encoders used to encode each modality of the multimodal input. In particular, the encoder and decoder for a particular modality can have been jointly trained as part of an auto-encoder neural network, e.g., so that the decoder has learned to reconstruct inputs from the tokens generated by the encoder. For example, in the particular example depicted, the system can use a visual decoder 280, e.g., the MAGVIT-v2 decoder to the MAGVIT-v2 encoder, to generate the output video 290 and can use an audio decoder 285, e.g., the corresponding decoder to the encoder 245, to generate the audio output 295.

Since the generated output depends on the input sequence of token embeddings 200 and decoding of the output sequence of token embeddings 250, during training of the autoregressive token generation model 150, one or more of the modality encoders, decoders, or both, e.g., as described above, can be trained with the autoregressive token generation model 150. In particular, the system can iteratively calculate and backpropagate gradients of the multimodal objective function of the token generation model 150 using the update rule of any appropriate gradient descent optimization algorithm, e.g., RMSprop or Adam to update the values of respective encoder or decoder model parameters. In other cases, the system can freeze the values of the respective encoder or decoder model parameters, e.g., the system can train the model 150 using frozen encoders and decoders with static valued parameters during training. In yet another example, the system can train the model 150 with both frozen and unfrozen encoders and decoders, e.g., the system can use a frozen text encoder-decoder pair and a frozen audio encoder-decoder pair but update the model parameters of the visual encoder-decoder pair in each model 150 training iteration.

In some cases, the autoregressive token generation model 150 can be trained using accelerated Alternating Gradient Descent, as described in detail in “Alternating Gradient Descent and Mixture-of-Experts for Integrated Multimodal Perception” (Akbari, H., et. al. doi: 10.48550/arXiv.2305.06324). In particular, the system can group each task by sequence length and alternately sample one group at each training iteration in a number of training iterations to train without padding.

FIG. 3 depicts an example super-resolution engine that can be used by the attention-based video generation system to generate a high-resolution video output, e.g., using the output of the autoregressive token generation model. As an example, the super-resolution engine can be used to process the output visual tokens of the autoregressive token generation model at a resolution of 224×128 to generate videos at a resolution of 896×512, e.g., increasing the resolution by approximately 1500%.

Generating high-resolution videos with an autoregressive transformer can incur a high computational cost due to the tokenized sequence length, e.g., processing a 17×896×512 video with a MAGVIT-v2 decoder produces a sequence of 25,840 tokens, and the quadratic memory cost of self-attention layers. In the case in which the autoregressive token generation model is implemented as a decoder-only transformer, the decoder-only model can employ a windowed local-attention mechanism, e.g., the model can be restricted to attending tokens within a fixed-size window in the output sequence of tokens, to mitigate the computational requirements involved. In particular, the system can employ a non-autoregressive video transformer with windowed-local attention along each of a temporal, spatial vertical, and spatial horizontal axis to increase video resolution within the latent token space in order to generate a super-resolution output.

As an example, the system can use a super-resolution engine 300 to generate a sequence of high-resolution output token embeddings 360. In the particular example depicted, the system can process and factorize the generated low-resolution token embeddings 290, e.g., as generated by the autoregressive token generation model 150, and a corresponding initial set of high-resolution token embeddings, e.g., the corresponding high-resolution masked token embeddings 310. In this case, the system can use the corresponding high-resolution masked tokens 310 for training the super-resolution engine 300, e.g., by treating the unmasked portions as the ground truth output as will be described in further detail below. In another case, e.g., during inference, the system can initialize the corresponding initial set of high-resolution token embeddings and can use the windowed local-attention mechanism to update values of the initial set of high resolution token embeddings to generate the output set of high-resolution token embeddings 360.

In particular, the super-resolution engine 300 can process and factorize the generated low-resolution tokens 290, e.g., the super-resolution engine 300 can factorize the vocabulary codebook from which the autoregressive token generation model generated the output tokens. As an example, an output from a first vocabulary codebook of size 212 can be factorized into two outputs from two subsets of the first vocabulary codebook of size 26, three outputs from three subsets of the first vocabulary codebook of size 24, etc. In this case, the engine 300 can generate a factorized output for the generated low-resolution tokens 290 and the initialized high-resolution masked tokens 310 by predicting tokens from each codebook, e.g., combining the factorized codebooks to produce a larger effective output codebook size.

The super-resolution engine 300 can then use a multi-axis transformer block 340 to employ the windowed local-attention mechanism, e.g., by including one transformer layer for each axis along which attention is performed. For example, the multi-axis transformer block 340 can employ three transformer layers to perform self-attention using a local window aligned with temporal 342, spatial horizontal 344, and spatial vertical 346 axes. In some cases, the size of the window, e.g., the size of the attention-window for each axis, can be predetermined. In other cases, the size of the window can be dynamically determined, e.g., based on the relative position of the low-resolution token in the sequence 290. In particular, the engine 300 can cross-attend the high-resolution tokens 310 with the low-resolution tokens 290 along each axis 342, 344, and 346 and can also self-attend the high-resolution tokens 310.

In some cases, the super-resolution engine 300 can condition the generation of the high-resolution output token embeddings 360 on additional inputs, e.g., embeddings. In the particular example depicted, the super-resolution engine 300 can also process text embeddings from a frozen text encoder, e.g., the text embeddings 335 can be generated by a t5 encoder. In this case, the system can also cross-attend the high-resolution tokens with the text 310 embeddings 335 to ensure consistency of output, e.g., based on the vocabulary of the text encoder.

The engine 360 can then perform multi-head classification and merging 350. In the particular example depicted, since the input tokens were factorized into a multiple of two, the system can use two prediction heads to make a prediction in each subspace and can combine the outputs as the final prediction. More specifically, the engine 360 can configure the multi-axis transformer block to predict in two codebooks of size 26, e.g., by processing two mutually exclusive subsets of the embedding matrix with two prediction heads, and can concatenate the smaller codebooks as the high-resolution output tokens 360.

In some cases, the system can train the multi-axis transformer block 340 using masked inputs, e.g., the corresponding high-resolution masked tokens 310, e.g., using the same objective function that is used to train the visual encoder-decoder pair. As an example, the system can downsample versions of the ground truth high-resolution videos, e.g., using bicubic filtering, and can apply noise augmentation in the discrete latent space to generate a corresponding lower-resolution output. In this case, the system can use non-autoregressive sampling with classifier-free guidance during inference, e.g., by combining a conditional and unconditional denoising score estimate, to improve the quality of generated images.

FIG. 4 demonstrates an example task chaining of an example autoregressive token generation model.

As described in FIG. 1, the autoregressive token generation model can be trained using task tokens, e.g., special tokens included in the input sequence of embeddings to condition the generated output based on the particular task. In this case, each corresponding task token is used to condition the output in accordance with each multimodal generative task. In particular, the system can identify a mixture of tasks to produce a foundation model capable of general purpose video generation during pretraining and can adapt the model to produce more specialized outputs during task adaptation. In particular, the system can finetune the autoregressive token generation model to enhance the quality of the video output, e.g., the resolution or fidelity of motion in the video output.

As an example, the system can define a prefix input indicative of the type of task the model is being trained on, e.g., such that the model conditions on the prefix. More specifically, the model can be pretrained on one or more multimodal generative tasks by prepending a set of corresponding task tokens, e.g., one or more task tokens, indicative of using the model input for training a particular generative task objective to each input sequence of embeddings.

For example, example tasks can include unconditioned video generation, e.g., generating video frames without conditioning on an input, text-to-video generation, e.g., generation of video frames from a text prompt, or video prediction, e.g., generating future frames of an input video. As another example, example tasks can include image-to-video generation, e.g., prediction of future video frames from a first video frame, video inpainting or outpainting, e.g., prediction of a video with masked contents filled in or contents extended beyond the input frame, or video stylization, e.g., modifying video style from one or more of a text prompt, optical flow, depth, or first frame of a video. As yet another example, example tasks can include audio-video, e.g., prediction of the corresponding video from an audio input, or video-to-audio, e.g., predicting the corresponding audio waveform for a video without sound.

After pretraining, the autoregressive token generation model can function as a versatile multitask video generation model and can perform tasks such as text-to-video, image-to-video, video editing and video-to-video stylization. In some cases, the autoregressive token generation model can exhibit zero-shot video generation capabilities. In particular, the system can generalize from data seen during training to perform a sequentially chained task, e.g., by sequentially chaining two or more multimodal generative tasks, e.g., to result in a specialized output. In the particular example depicted, the system can process the original video 420 and the prompt 460 “A gingerbread and candy train on a track” and chain an outpainting task and a stylization task.

More specifically, the system can perform a first multimodal generative task by prepending the set of corresponding task tokens for the first multimodal generative task to the model input, e.g., by prepending an outpainting task token to the tokens generated by encoding the original video 420. The system can then process the resultant input sequence of embeddings to generate a first model output using the prepended set of corresponding task tokens, e.g., by conditioning on the prepended outpainted task token. In this case, the system can decode the output set of tokens to generate the outpainted video 440. The system can then perform a second multimodal generative task by prepending the set of corresponding task tokens for the second multimodal generative task to the first model output, e.g., by prepending a stylization task token to the output set of tokens from the first task, to generate a second model output, e.g., an output set of tokens that can be decoded to generate the stylized video 460.

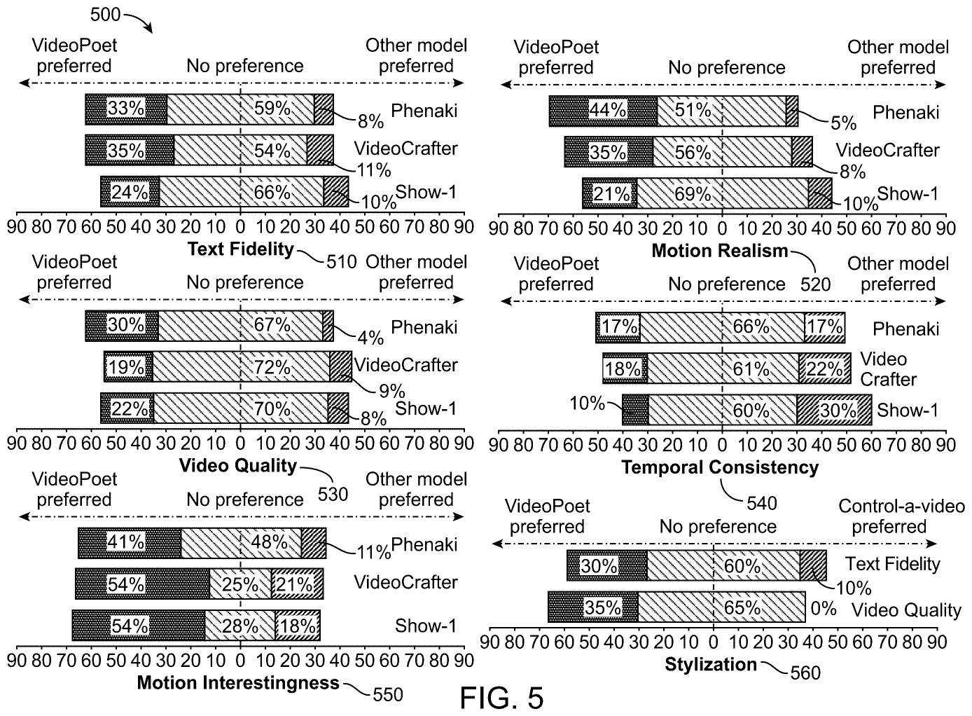

FIG. 5 depicts user preference results for outputs generated using an example attention-based video generation system, e.g., the attention-based video generation system 100 of FIG. 1. In particular, FIG. 5 provides user evaluations 500 comparing outputs from an autoregressive token generation model, e.g., VideoPoet, to other text-to-video generative model approaches relative to particular attributes of the generated video in graphs 510, 520, 530, 540, 550, and 560.

More specifically, the graphs 510-550 compare VideoPoet to three different text-to-video generative models: Phenaki, VideoCrafter, and Show-1, that aim to generate a high-resolution video output. Phenaki is a specialized encoder-transformer-decoder model that compresses videos to discrete text embeddings, translates text embeddings to video tokens, and decodes the video tokens. VideoCrafter is a diffusion model that leverages UNet to embed image features and integrates conditional text embeddings with the image features using an attention-model. Show-1 uses a pixel-based text-to-video diffusion model (VDM) to generate a low-resolution video and then uses a latent-based VDM to upsample the low-resolution video. Additionally, the graph 560 compares VideoPoet to a video-stylization model, e.g., the Control-A-Video model. Control-A-Video is a pretrained conditional text-to-image diffusion model conditioned using edge and depth-maps.

In the particular example depicted, the user evaluations 500 were performed by showing multiple users a pair of videos generated by two respective models at the same time, e.g., in a randomized order, and asking users to compare the videos and to report which video they preferred with respect to six identified quality attributes. More specifically, users were asked to consider text fidelity, e.g., which video follows the text prompt most faithfully, video quality, motion interestingness, motion realism, and temporal consistency.

In this case, the aggregated results for user evaluation with respect to each quality attribute corresponds with a graph. For example, the graph 510 corresponds with text fidelity, the graph 520 corresponds with motion realism 520, and the graph 530 corresponds with video quality. As another example, the graph 540 corresponds with temporal consistency, the graph 550 corresponds with motion interestingness, and the graph 560 corresponds with stylization. In particular, thick hashed, thin backslashed, and checkerboard bars represent the proportion of trials where the autoregressive token generation model was preferred over an alternative, similar to, or less preferred to an alternative, respectively, in the results 500.

In the particular example depicted, the graphs 500-550 show that the autoregressive token generation model generally outperforms the baseline models along almost all of the quality attributes, e.g., text fidelity, video quality, motion interestingness, and motion realism. In particular, the autoregressive token generation model is most preferred with respect to the motion categories. With respect to temporal consistency, the autoregressive token generation model slightly underperforms relative to the Show-1 model, but outperforms the Show-1 model on motion interestingness and motion realism. In particular, this discrepancy in perform can represent a trade-off between motion interestingness and temporal consistency, e.g., the generation of more interesting larger motions can correlate with a greater possibility of producing noticeable artifacts. For example, a static scene is more temporally consistent but less interesting. Additionally, the graph 560 demonstrates how the autoregressive token generation model outperforms Control-A-Video by a large margin with respect to both text fidelity and video quality.

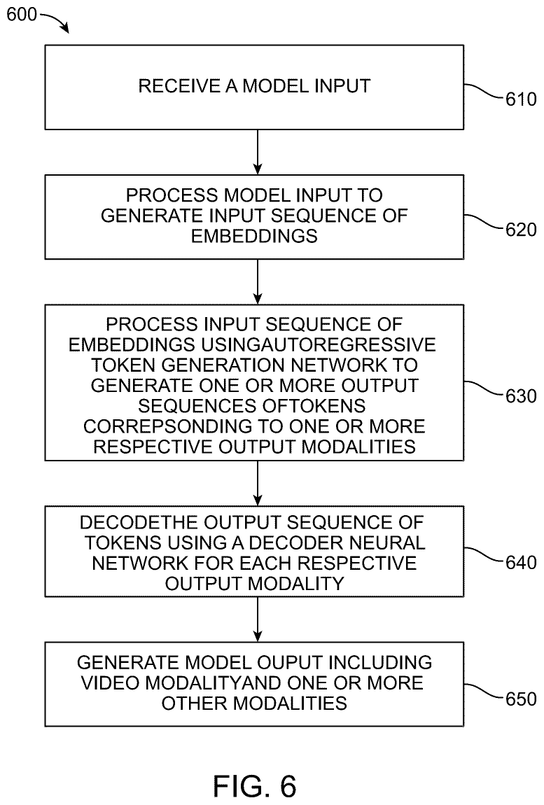

FIG. 6 is a flow chart of an example process for processing a model input to generate a video output using an autoregressive token generation model. For convenience, the process 600 will be described as being performed by a system of one or more computers located in one or more locations. For example, an attention-based video generation system, e.g., the attention-based video generation system 100 of FIG. 1, appropriately programmed in accordance with this specification, can perform the process 600.

In particular, the system can receive a model input (step 610), e.g., from a user. As an example, the model input can be a multimodal input that can include one or more modalities. For example, the model can include one or more of a text input, image input, video input, or audio input modality. In some cases, the video input modality can include a masked, depth-map, or optical flow input, e.g., the system can receive or generate the masked, depth-map, or optical flow input.

The system can process the model input to generate an input sequence of embeddings (step 620). As an example, the system can process each of the respective input modalities using a respective tokenizer and can embed the resultant output tokens with a respective embedding model or an embedding layer of the autoregressive token generation model. As another example, the system can encode each modality of the model input using a respective encoder neural network, e.g., a network configured to process the respective modality input to generate a representation of the data in a latent embedding space, to generate an input sequence of embeddings. More specifically, the system can process the multimodal input using one or more of respective tokenizers and encoders to generate respective embeddings and can combine, e.g., concatenate, the respective embeddings into the input sequence of embeddings. In particular, the system can embed or encode each of the modalities into an input space of a unified vocabulary e.g., a defined fixed-size set of concepts across the modalities.

The system can then process the input sequence of embeddings using an autoregressive token generation model to generate one or more output sequences of tokens corresponding to one or more respective output modalities (step 630), e.g., based on a particular generative task. As an example, the system can generate an output for a text to video task, an image to video task, a video to audio task, a video stylization task, an inpainting task, an outpainting task, etc. In particular, the system can process the input sequence of embeddings using the autoregressive token generation model, e.g., a decoder-only transformer model, to generate an output. More specifically, the system can autoregressively generate sequences of tokens for each output modality, e.g., each modality as required by the specific generative task, from the same vocabulary of tokens.

For example, the autoregressive token generation model can be a decoder-only transformer network. In this case, the autoregressive token generation model can be pretrained on one or more multimodal generative tasks, e.g., by prepending a task token indicating the task to be performed and conditioning the model output using the task token. The pretrained model can then serve as a foundation model that can be adapted for a range of video generation tasks during task adaptation, e.g., the system can finetune the pretrained model using one or more of the multimodal generative tasks. In some cases, the system can finetune the pretrained model to perform a sequentially chained generative task, e.g., by prepending a second task token to the first model output and generating a second model output using the second corresponding task token.

The system can decode the output sequence of tokens using a decoder neural network for each respective output modality (step 640) in order to generate a model output including a video modality and one or more other modalities (step 650). In the particular, the system can use the corresponding decoders to the encoders used to encode the generated sequence of tokens, e.g., the system can process the text tokens with a text decoder, the visual tokens with a visual decoder, and the audio tokens with an audio decoder. As an example, the system can generate a stylized video output, inpainted video output, outpainted video output. As an another example, the system can generate a video in a text to video or audio to video text.

In some cases, the system can generate high-resolution visual tokens, e.g., by processing the low-resolution tokens using a super-resolution engine. For example, the super-resolution engine can cross-attend the low-resolution tokens with corresponding high-resolution tokens along one or more axes, e.g., a spatial vertical, spatial horizontal, and temporal axis, and self-attend the high-resolution tokens.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for generating an output comprising an output video, the method comprising:
obtaining a model input;
processing the model input to generate an input sequence of embeddings that represents the model input;
autoregressively generating, by processing the input sequence of embeddings using an autoregressive token generation neural network, a combined output sequence that comprises a plurality of output sequences of tokens from a unified vocabulary of tokens, wherein each output sequence of tokens corresponds to a respective output modality of tokens from a set of a plurality of modalities that includes a video modality and one or more other modalities; and
generating a model output that includes a video output of the video modality and a respective output for each of the one or more other modalities, comprising, for each output sequence of tokens, decoding the sequence of tokens using a decoder neural network corresponding to the modality of the output sequence to generate an output of the modality of the output sequence.

2. The method of claim 1, wherein obtaining the model input comprises receiving a respective input for each of one or more input modalities from a set of a plurality of input modalities, the plurality of input modalities comprising one or more of text, image, video, or audio modality inputs.

3. The method of claim 1, wherein obtaining the model input comprises:
obtaining one or more of pixel masks or monocular depth maps of a first video frame in a video modality input.

4. The method of claim 1, wherein the model input comprises a text modality input, and wherein processing the text modality input to generate an input sequence of embeddings that represents the text modality input comprises:
processing the text modality input using a text encoder to generate a sequence of text embeddings; and
mapping the text embeddings in the sequence of text embeddings to a subset of the embeddings in the input sequence of embeddings.

5. The method of claim 1, wherein the model input comprises one or more of image, video, or audio modality inputs, and wherein processing the one or more of the image, video, or audio modality inputs to generate an input sequence of embeddings that represents the one or more of the image, video, or audio modality inputs further comprises:
processing each modality input of the one or more of the image, video, or audio modality inputs using a respective encoder model corresponding to the modality of the modality input to generate a respective sequence of token embeddings from the modality input.

6. The method of claim 5, wherein processing each modality input of the one or more of the image, video, or audio modality inputs using a respective encoder model corresponding to the modality of the modality input to generate a respective sequence of token embeddings from the modality input comprises:
encoding the video modality input comprising encoding each of a plurality of segments of the video using a temporally-consistent visual tokenizer; or
encoding the image modality input as a single video frame using the temporally-consistent visual tokenizer.

7. The method of claim 6, wherein processing each modality input of the one or more of the image, video, or audio modality inputs using a respective encoder model corresponding to the modality of the modality input to generate a respective sequence of token embeddings from the modality input comprises:
encoding the audio modality input using a residual vector quantizer to generate one or more vectors from a set of vector codebooks, each codebook specifying a respective frequency of the audio modality input.

8. The method of claim 1, wherein autoregressively generating the output sequence of tokens comprises:
generating a sequence of video modality tokens comprising a sequence of image modality tokens with corresponding audio modality tokens.

9. The method of claim 8, further comprising generating a sequence of high-resolution image modality tokens from the image modality tokens, wherein generating a sequence of high-resolution image modality tokens comprises using a non-autoregressive bidirectional transformer with windowed local-attention comprising:
cross-attending the super-resolution image modality tokens with the image modality tokens along each of a spatial vertical, spatial horizontal, and temporal axis; and
self-attending the super-resolution image modality tokens.

10. The method of claim 1, wherein the autoregressive token generation neural network has been trained, the training comprising:
pretraining the autoregressive token generation neural network on one or more multimodal generative tasks by prepending a task token from a set of corresponding task tokens indicative of using the model input for training a particular generative task objective to each input sequence of embeddings, wherein each corresponding task token is used to condition the output in accordance with each multimodal generative task; and
fine-tuning the autoregressive token generation neural network based at least on one of the multimodal generative tasks.

11. The method of claim 10, further comprising processing a training set of model inputs comprising one or more of a plurality of labelled image-text pairs and a plurality of unlabeled video-only data items.

12. The method of claim 11, wherein the plurality of labelled image-text pairs includes a first number of model inputs and the plurality of unlabeled video-only data items includes a second number of model inputs, and wherein the first number is greater than the second number.

13. The method of claim 12, wherein pretraining comprises:
sampling a larger portion of the training set of model inputs from the plurality of labelled image-text pairs for a first number of training iterations; and
sampling a larger portion of the training set of model inputs from the unlabeled video-only data items for a remainder of the training iterations after the first number of training iterations.

14. The method of claim 10, further comprising processing the model input in accordance with sequentially chaining two or more multimodal generative tasks.

15. The method of claim 14, wherein sequentially chaining two or more multimodal generative tasks comprises:
performing a first multimodal generative task by prepending a first corresponding task token for the first multimodal generative task to the model input;
generating a first model output using the first corresponding task token;
performing a second multimodal generative task by prepending a second corresponding task token for the second multimodal generative task to the first model output; and
generating a second model output using the second corresponding task token.

16. The method of claim 1, wherein generating the model output that includes the video modality and the one or more other modalities comprises generating a stylized video output.

17. The method of claim 1, wherein generating the model output that includes the video modality and the one or more other modalities comprises generating an inpainted video output.

18. The method of claim 1, generating the model output that includes the video modality and the one or more other modalities comprises generating an outpainted video output.

19. A system comprising one or more computers and one or more storage devices storing instructions that are operable, when executed by the one or more computers, to cause the one or more computers to perform operations comprising:
obtaining a model input;
processing the model input to generate an input sequence of embeddings that represents the model input;
autoregressively generating, by processing the input sequence of embeddings using an autoregressive token generation neural network, a combined output sequence that comprises a plurality of output sequences of tokens from a unified vocabulary of tokens, wherein each output sequence of tokens corresponds to a respective output modality of tokens from a set of a plurality of modalities that includes a video modality and one or more other modalities; and
generating a model output that includes a video output of the video modality and a respective output for each of the one or more other modalities, comprising, for each output sequence of tokens, decoding the sequence of tokens using a decoder neural network corresponding to the modality of the output sequence to generate an output of the modality of the output sequence.

20. A computer storage medium encoded with a computer program, the program comprising instructions that are operable, when executed by data processing apparatus, to cause the data processing apparatus to perform operations comprising:
obtaining a model input;
processing the model input to generate an input sequence of embeddings that represents the model input;
autoregressively generating, by processing the input sequence of embeddings using an autoregressive token generation neural network, a combined output sequence that comprises a plurality of output sequences of tokens from a unified vocabulary of tokens, wherein each output sequence of tokens corresponds to a respective output modality of tokens from a set of a plurality of modalities that includes a video modality and one or more other modalities; and
generating a model output that includes a video output of the video modality and a respective output for each of the one or more other modalities, comprising, for each output sequence of tokens, decoding the sequence of tokens using a decoder neural network corresponding to the modality of the output sequence to generate an output of the modality of the output sequence.
